(19) United States
(12) Patent Application Publication
(10) Pub. No.: US 2003/0008110 A1
(43) Pub. Date: Jan. 9, 2003

(54) Swell-resistant multi-layer products and methods for producing same

(76) Inventor: Wu-Hsiung Ernest Hsu, Tualatin, OR (US)

Correspondence Address: MARGER JOHNSON & MCCOLLOM PC, 1030 SW MORRISON STREET, PORTLAND, OR, 97205, US

(21) Appl. No.: 09/887,534

(22) Filed: Jun. 21, 2001

(51) Int. Cl. B32B 23/02; B32B 7/14

(52) U.S. Cl. 428/194; 156/291

(57) ABSTRACT

The method of present invention comprises forming a mat of a plurality of layers of lignocellulosic material, having first and second outer surfaces. The mat includes first bands of an adhesive bonding material applied on at least one of the first and second outer surfaces, between each pair of adjacent layers, at a location extending adjacent to the longitudinally-extending outer edges of the product. Then, the plurality of layers of lignocellulosic material of the mat are bonded together to form the multi-layer lignocellulosic product which exhibits a relative small difference in the edge swell, after wetting, of at least one of the outer surfaces as compared to at least one of the longitudinally-extending and laterally-extending outer edges, respectively.

### BACKGROUND OF THE INVENTION

This invention relates to multi-layer products which exhibit a substantially reduced level of edge and differential thickness swell, and to methods for producing and using the subject products.

Multi-layer lignocellulosic products employing adhesive bonding agents have been known for many years. Adhesive bonding agents such as isocyanates (in particular “MDI”) have been used in the wood industry for almost 25 years.

These materials have been used as adhesives for particulate wood products such as oriented strand board (“OSB”) and particleboard and fiberboard. A resin such as MDI exhibits excellent strength capabilities and is capable of bonding together the lignocellulose particles which form these particulate wood products.

For example, OSB-fiberboard composite structures can be made using PMDI resins. Such methods are described in U.S. Pat. No. 5,425,976, U.S. 5,470,631, U.S. 5,525,394, and U.S. 5,718,786. In one such method described in U.S. Pat. No. 5,534,295 (“'295 patent”), a polyurethane and/or a polyurea elastomeric coating material is sprayed on the sanded edges of a plurality of aligned wooden substrates for the express purposed of forming a protective, smooth coating which is said to be resistant to chipping and peeling. The material sprayed on the sanded edges in the '295 patent does not, however, substantially strengthen them or the board as a whole.

However, problems other than those which can be solved by merely edge sealing a substrate as described in the '295 patent do exist, particularly with respect to certain particulate multi-layer products. For example, moisture induced swell of the edges of these products is a serious problem. More specifically, certain of these products experience substantial edge swell, and also exhibit significant edge swell relative to the level of swell of the interior surfaces of that product. For instance, in flooring systems formed of a multi-layer lignocellulosic product, such as depicted in FIGS. 1 and 2, extensive edge and differential thickness swell of these products due to the presence of moisture causes the unwanted formation of an uneven outer surface having a significant number of external raised portions. This is a dilemma because the resultant contour of the outer surfaces of arrangements of a plurality of these products, such as in flooring applications, does not have the requisite uniform overall flat configuration.

All of the issued patents cited in this application are incorporated in their entirety by reference.

### SUMMARY OF THE INVENTION

It has now been discovered that, in accordance with the present invention, a method can be provided for manufacturing multi-layer lignocellulosic products, which have a substantially increased resistance to the effects of edge and differential thickness swell caused by moisture. Moisture-induced edge thickness swell and differential thickness swell problems, which exist with respect to prior art multi-layer products, are effectively reduced in the subject multi-layer wood products. Consequently, the products of this invention can be ultimately employed, for example, in a number of end uses which employ products having relatively low levels of edge thickness swell and differential thickness swell, such as in flooring systems and the like. Accordingly, since unwanted thickness swell of the subject product due to the presence of moisture is substantially decreased, the formation of a substantially uneven outer surfaces having considerable unwanted raised portions is also diminished.

In the method of the present invention, an adhesive material is employed to reinforce the bonding effect between the respective layers of lignocellulosic material, which forms the ultimate multi-layer product. The adhesive material is applied to the surface of at least a portion of this lignocellulosic material, particularly to at least a portion of the lignocellulosic material located adjacent to the edges thereof, in order to achieve the requisite bonding effect described above.

According to the teachings of the present invention, a method is provided for forming a multi-layer lignocellulosic product having a substantially reduced level of edge thickness swell. Preferably, the product of this invention also has a substantially reduced level of differential thickness swell.

The subject product, which is formed by the method described herein, has a plurality of outer surfaces including a plurality of longitudinally-extending outer edges, a plurality of laterally-extending outer edges, and interior outer surfaces located therebetween. After wetting the product of this invention, it displays a substantially reduced amount of edge thickness swell. The product of this invention also exhibits a relatively reduced amount of differential thickness swell between the interior surfaces of the product and the outer edges of the product, respectively.

The method of the present invention typically comprises the following steps in forming the product of the present invention. First, a mat is formed of a plurality of layers of lignocellulosic material having outer surfaces. At least one band of an adhesive bonding material is applied to the outer surfaces of the layers of lignocellulosic material, between each pair of adjacent layers, at a location adjacent to the longitudinally-extending outer edges of the mat, to form a treated mat. Then, the plurality of layers of lignocellulosic material of the treated mat are bonded together to form a multi-layer lignocellulosic product.

The multi-layer lignocellulosic product of the present invention which is formed from the treated mat exhibits, after wetting, an average edge thickness swell (“Edge Swell”) which is significantly less than that of a multi-layer lignocellulosic product formed from an untreated mat produced from a plurality of layers of said lignocellulosic material to which a band of adhesive bonding material band has not been applied. For purposes of this invention, Edge Swell is the extent of thickness swelling of the edge of a multi-layer lignocellulosic product after exposure to water or moisture for a predetermined amount of time.

The subject product also exhibits, after wetting, an average differential thickness swell (“Differential Swell”) which is significantly less than that of a multi-layer lignocellulosic product formed from an untreated mat produced from a plurality of layers of said lignocellulosic material to which a band of adhesive bonding material band has not been applied. For purposes of this invention, Differential Swell is the respective difference between (a) the Edge Swell of a multi-layer lignocellulosic product and (b) the extent of thickness swelling of the multi-layer lignocellulosic product of (a) measured one inch from the edge.

More specifically, the Edge Swell of the multi-layer lignocellulosic product of this invention, after wetting, is preferably at least about 20% less than, more preferably at least about 25% less than, and most preferably at least about 30% less than, the Edge Swell of a multi-layer lignocellulosic product produced from an untreated plurality of layers of said lignocellulosic material to which a band of adhesive bonding material band has not been applied. Furthermore, the Differential Swell of the multi-layer lignocellulosic product of this invention, after wetting, is preferably at least about 25% less than, more preferably at least about 30% less than, and most preferably at least about 35% less than, the Differential Swell of a multi-layer lignocellulosic product produced from an untreated plurality of layers of said lignocellulosic material to which a band of adhesive bonding material band has not been applied.

Fastener ultimate load (extraction) of the multi-layer lignocellulosic product of this invention was also determined pursuant to ASTM-D1037. The fasteners used in testing fastener ultimate load (extraction) were six-penny wire nails. Fastener ultimate load (extraction) tests were conducted on the products made from treated mats and untreated mats, respectively. The ultimate load (extraction) of the subject product, after wetting, is preferably at least about 30% more than, more preferably at least about 40% more than, and most preferably at least about 50% more than, the ultimate load (extraction) of a multi-layer lignocellulosic product produced from an untreated plurality of layers of said lignocellulosic material to which a band of adhesive bonding material band has not been applied.

The concentrated static load (“CSL Load”) of the multi-layer lignocellulosic product of this invention was also determined pursuant to ASTM-E-661. CSL tests were conducted on the products made from treated mats and untreated mats, respectively. The CSL Load of the subject product, after wetting, is preferably at least about 20% more than, more preferably at least about 25% more than, and most preferably at least about 30% more than, the CSL Load of a multi-layer lignocellulosic product produced from an untreated plurality of layers of said lignocellulosic material to which a band of adhesive bonding material band has not been applied.

The lignocellulosic material typically comprises lignocellulosic particles. Furthermore, the layers of lignocellulosic material can also comprise lignocellulosic veneers. Moreover, the multi-layer lignocellulosic product preferably comprises a tongue-in-groove multi-layer lignocellulosic product.

As for the bands of adhesive bonding material, they preferably extend in a direction substantially parallel to at least one of the outer edges of the product. At least a portion of the bands of the adhesive bonding material are typically located within up to about 2.0 inches, preferably within up to about 1.5 inches, and more preferably within up to about 1.0 inch, of at least one of the outer edges of the product. In the most preferably case, the bands of adhesive bonding material are located immediately adjacent the outer edges of the product.

The multi-layer lignocellulosic product can also include at least one reinforcing strip in conjunction with an adhesive bonding material and preferably a plurality of reinforcing strip s in conjunction with an adhesive bonding material. Typically, the reinforcing strip is impregnated with an adhesive bonding material so that it becomes associated with the reinforcing structure. In it's desired form, the reinforcing strip is a narrow elongated solid piece, preferably having length and width dimensions substantially similar to the band of adhesive bonding material described herein. The reinforcing strip typically comprises a polymeric, glass or carbon materials, preferably glass fibers, carbon fibers, a polycarbonate, or a polyolefin, and more preferably fiberglass, Kevlar or high density polyethylene. The adhesive material included in conjunction with the reinforcing strip are substantially similar to the adhesive bonding material used to form the band described herein. Preferably, the adhesive material is an aldehyde and/or isocyanate polymer as described herein.

A method for forming a substantially flat, integrated arrangement of the multi-layer lignocellulosic product described above, employing the methods of formation of the product previously set forth herein, is also contemplated by this invention. The subject multi-layer lignocellulosic products produced according the teaching of the present invention can be formed into a substantially flat, integrated arrangement which exhibits the above-described characteristics associated respectively with a substantially reduced level of Edge Swell as well as a substantially reduced level of Differential Swell.

### BRIEF DESCRIPTION OF THE DRAWINGS

FIG. 1 is a schematic perspective view of a multi-layer lignocellulosic product which has undergone moisture-induced swell.

FIG. 2 is a view taken along line 2-2 of FIG. 1.

FIG. 3 is a schematic perspective exploded view of exemplary layers of lignocellulosic material onto which bands of an adhesive bonding material have been applied.

FIG. 4 is a schematic end view of a multi-layer product produced by the method of the present invention which has not undergone substantial moisture induced swell.

### DETAILED DESCRIPTION OF A PREFERRED EMBODIMENT

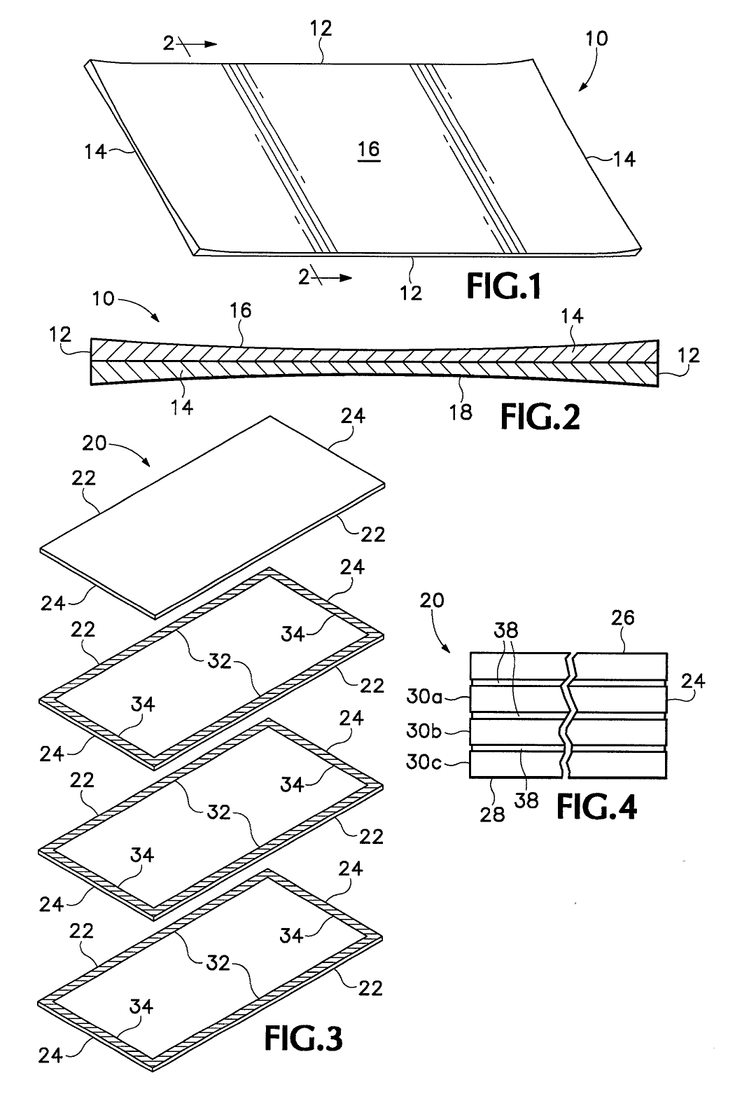

Referring now to FIGS. 1 and 2, a multi-layer lignocellulosic product 10, which has undergone an unsatisfactory level of moisture induced swell, is depicted. As shown in FIGS. 1 and 2, the longitudinally-extending edges 12 and the laterally-extending edges 14 of the product 10 exhibit an Edge Swell which is commercially unacceptable. Also as depicted in FIGS. 1 and 2, the longitudinally-extending edges 12 and the laterally-extending edges 14 of the product 10 exhibit a commercially unacceptable Differential Swell, as compared to the outer face of interior surfaces 16 and 18, respectively.

Referring now to FIG. 4, the subject multi-layer lignocellulosic product 20, produced by the method of the present invention, which has not undergone an unsatisfactory level of moisture induced swell, is depicted. Also as shown in FIG. 4, the longitudinally-extending edges 22 and the laterally-extending edges 24 of the product 20 exhibit an Edge Swell which is commercially acceptable. Also as depicted in FIG. 4, the longitudinally-extending edges 22 and the laterally-extending edges 24 of the product 20 exhibit a commercially acceptable Differential Swell, as compared to the outer face of interior surfaces 26 and 28, respectively.

Referring now to FIG. 3, a perspective exploded view of product 20, formed of a lignocellulosic material, having exemplary layers 30a-30c, is depicted. Bands 32 and 34 of an adhesive bonding material have been applied to certain of the layers 30. Also, a thin layer 38 of adhesive bonding material is applied onto the plurality of longitudinally-extending outer edges 22 and the plurality of laterally-extending outer edges 24, respectively. Bands 32 of the adhesive material are typically applied at a location extending adjacent to the longitudinally-extending outer edges 22 of the product 20. Bands 34 of the adhesive material can be applied at locations between the laterally-extending outer edges 24 of the product 20.

The term “multi-layer lignocellulosic product”, as used herein, describes a number of lignocellulosic board products. Examples of products formed of lignocellulosic particles are particleboard, chipboard, waferboard, fiberboard, plywood and oriented strandboard. It can also be employed for products formed of lignocellulosic veneers such as plywood and the like.

The multi-layer lignocellulosic products of this invention can be prepared by application of an adhesive bonding material to lignocellulosic particles, chips or fibers, specifically wood particles, wood chips and lignocellulosic fibers, which are formed into layers. A plurality of bands of adhesive bonding material is applied to the surface of certain of these layers so that adjacent layers can be bonded together and formed into the desired multi-layer product through application of heat and pressure. Similarly, the method of the present invention and its attended advantages can be achieved with respect to various forms of lignocellulosic starting material and is not limited to any particular form. The use of wood particles, chips or fibers, however, in the formation of a typical particleboard comprises the preferred environment for the method of the present invention.

Also, instead of first forming a layer by bonding together lignocellulosic particles or the like, layers or sheets of lignocellulosic material, such as veneer layers or sheets such as those used to manufacture plywood or the like, can be provided and used to form the subject multi-layer lignocellulosic product. Such a formation method is accomplished by the application of a plurality of bands of adhesive bonding to the surfaces of certain of the veneer layers or sheets.

Mixtures of lignocellulosic particles may be used. Typically, such materials are wood particles derived from wood and wood residues such as wood chips, wood fibers, shavings, veneers, wood wool, cork, bark, sawdust, and the like. Particles of other lignocellulosic material such as shredded paper, pulp or vegetable fibers such as corn stalks, straw, bagasse and the like may also be used.

The adhesive bonding system of the present invention generally comprises an isocyanate polymer and/or an aldehyde polymer resin. The adhesive bonding system can also be an isocyanate/latex copolymer or a phenol-formaldehyde/latex copolymer. The polymers which form the adhesive bonding system are typically in liquid form so that they can be applied directly to a surface of a layer of lignocellulosic material. The polymer resins can be combined together prior to their application.

The aldehyde polymer resins can comprise thermosetting resins such as phenol-formaldehyde, resorcinol-formaldehyde, melamine-formaldehyde, urea-formaldehyde, modified lignosulfonates, urea-furfural and condensed furfuryl alcohol resins. The phenolic component can include any one or more of the phenols which have heretofore been employed in the formation of phenolic resins and which are not substituted at either the two ortho-positions or at one ortho- and the para-position, such unsubstituted positions being necessary for the polymerization reaction. Any one, all, or none of the remaining carbon atoms of the phenol ring can be substituted. The nature of the substituent can vary widely, and it is only necessary that the substituent not interfere in the polymerization of the aldehyde with the phenol at the ortho- and/or para-positions. Substituted phenols employed in the formation of the phenolic resins include: alkyl-substituted phenols, aryl-substituted phenols, cyclo-alkyl-substituted phenols, alkenyl-substituted phenols, alkoxy-substituted phenols, aryloxy-substituted phenols, and halogen-substituted phenols, the foregoing substituents containing from 1 to 26 and preferably from 1 to 12 carbon atoms. Specific examples of suitable phenols include: phenol, 2,6 xylenol, o-cresol, m-cresol, p-cresol, 3,5-xylenol, 3-4-xylenol, 2,3,4-trimethyl phenol, 3-ethyl phenol, 3,5-diethyl phenol, p-butyl phenol, 3,5-dibutyl phenol, p-amyl phenol, p-cyclohexyl phenol, p-octyl phenol, 3,5-dicyclohexyl phenol, p-phenyl phenol, p-crotyl phenol, 3,5-dimethoxy phenol, 3,4,5-trimethoxy phenol, p-ethoxy phenol, p-butoxy phenol, 3-methyl-4-methoxy phenol, and p-phenoxy phenol.

The aldehydes reacted with the phenol can include any of the aldehydes heretofore employed in the formation of phenolic resins such as formaldehyde, acetaldehyde, propionaldehyde, furfuraldehyde, and benzaldehyde. In general, the aldehydes employed have the formula R′CHO wherein R′ is a hydrogen or a hydrocarbon radical of 1 to 8 carbon atoms. The most preferred aldehyde is formaldehyde.

The isocyanate polymer may suitably be any organic isocyanate polymer compound containing at least 2 active isocyanate groups per molecule, or mixtures of such compounds. Generally, the isocyanate polymers employed in the method of this invention are those which have an isocyanato group functionality of at least about two. Preferably, this functionality ranges from 2.3 to 3.5 with an isocyanate equivalent of 132 to 135. The isocyanato functionality can be determined from the percent available NCO groups and the average molecular weight of the isocyanate polymer composition. The percent available NCO groups can be determined by the procedures of ASTM test method D1638.

The isocyanate polymers which can be employed in the method of the present invention can be those that are typically employed in adhesive compositions, including typical aromatic, aliphatic and cycloaliphatic isocyanate polymers. Representative aromatic isocyanate polymers include 2,4-tolylene diisocyanate, 2,6-tolylene diisocyanate, 4,4′-methylene bis(phenyl isocyanate), 1,3-phenylene diisocyanate, triphenylmethane triisocyanate, 2,4,4′ triisocyanato-diphenyl ether, 2,4-bis(4-isocyanatobenzyl) phenylisocyanate and related polyaryl polyiscocyanates, 1,5-naphthalene diisocyanate and mixtures thereof. Representative aliphatic isocyanate polymers include hexamethylene diisocyanate, xylylene diisocyanate, 1,12-dodecane diisocyanate and lysine ethyl ester diisocyanate. Representative cycloaliphatic isocyanate polymers include 4,4′-methylenebis (cyclohexyl isocyanate), 1,4-cyclohexylene diisocyanate, 1-methyl-2,4-cyclohexylene diisocyanate and 2,4-bis(4-isocyanatocyclhexylmethyl) cyclohexyl isocyanate. The isocyanate polymer is typically applied in its liquid form. Generally, when a phenol-formaldehyde resin is used as the phenolic resin it is present in the adhesive composition used in the method of the present invention within the range of about 50 to 90% by weight, preferably within the range of about 60 to 80% by weight of the total amount of adhesive. Generally, the isocyanate polymer is present in an amount of about 10% to 50% isocyanate polymer, preferably 20 to 40%, by weight. When the adhesive bonding system is used according to these percentages, one achieves a commercially attractive combination of desired board properties and economic advantages.

The formation of the layers of lignocellulosic material from lignocellulosic can involve the application of an adhesive bonding composition to the lignocellulosic particles with subsequent application of heat and pressure to form the layers into its desired consolidated configuration. It should be appreciated that the adhesive composition can be applied to the lignocellulosic particles in any conventional means, such as spray coating of the adhesive composition onto the lignocellulosic particles.

In the typical method of the present invention, the adhesive bonding system, as previously described, is applied in bands to one or more surfaces of a lignocellulosic layer by various liquid application techniques. For example, one preferred technique is by drooling a liquid adhesive bonding material onto a lignocellulosic layer through a tubular applicator or the like.

In a typical method (“Method”) of this invention for forming a lignocellulosic product 20 (“Product”) having a multi-layer structure depicted in FIG. 3, for example, a first layer 30a of lignocellulosic particles and combined adhesive bonding material is generally laid down on a formation surface such as a caul plate, belt or screen (not shown). This first layer 30a is termed the “face mix” and forms the face of the finished particleboard. After the first face mix 30a is laid on the formation surface, bands of adhesive bonding material 32, 34 and 36 are applied to a first surface thereof.

As shown in FIG. 3, bands of adhesive bonding material 32, 34 and 36 can be located at one or more position adjacent to or near the outer edges 22 and 24, or on the interior surfaces 26 and 28 of the first face 30a. Then, a second layer of lignocellulosic particles and adhesive bonding material is deposited as a second face mix 30b. This second layer of face mix 30b is termed the “core mix” since it will form the core of the finished particleboard 10. After the second layer is deposited on the caul, bands of adhesive bonding material 32, 34 and 36 can be applied to an outer surface thereof.

Following this, a third layer 30c of lignocellulosic particles and adhesive is layed down on top of the core mix of the second layer, 30b. This third layer 30c is also a face mix and will form the opposite face of the finished product 20. The three layers 30a-30c which are deposited on the caul plate are termed the “mat.”

The mat, including the caul plate, is loaded into a press (not shown), and a pressing operation is carried out in order to form the desired product 20. By way of example, a mat which has an initial thickness of about 3½ inches may be pressed down to a thickness of about 0.7 inch or a mat which has an initial thickness of 7 inches may be pressed down to a final thickness of approximately 1⅞ inches. During typical pressing operation, the mats are heated to a temperature of between about 395-430 degrees F. as they are being compressed at about 450-700 psi. The exact conditions utilized in the pressing and heat curing of the particleboard can, of course, be easily selected by one skilled in the art depending, of course, upon the desired characteristics of the final product.

### EXAMPLE 1

Experiments were conducted in order to evaluate the Product of the present invention which was formed according to the specific version of the Method as described below (“Method 1”). In one case, bands of adhesive bonding material were applied onto the surfaces of the layers of lignocellulosic material, at a location adjacent to both of the longitudinally-extending outer edges of the Product, in a pattern similar to that which is depicted in FIG. 3. As a control, Method 1 was repeated except that bands of adhesive bonding material were not applied onto the surfaces of the layers of lignocellulosic material as hereinafter described.

The specifics of Method 1 is as follows: Lignocelluosic strands comprising 80% by weight Aspen and 20% by weight mixed hardwoods, having an average thickness of about 0.024″, were dried to a 4% moisture content. These strands were blended with either MDI or phenol formaldehyde or adhesive bonding materials to form the core and two outer layers, respectively, of the lignocellulosic multi-layer mats (“Mats”) which made up the Product tested. The amount of phenol-formaldeyde resin in the two outer face layers mixes was about 3.5% by weight, and the amount of the MDI resin in the inner core layer mix was about 2.0% by weight. A dosage of E-Wax in an amount of about 1.0% by weight was also added. The Mats were pressed at a temperature of about 420 degrees F., for about 230 seconds of press time, thereby forming an 8′×16′ panel having a thickness before sanding of 0.730″ and a density of 41.0 lbs/cu.ft.

Longitudinally-extending bands of adhesive bonding material were applied to the Mat by drooling MDI resin from a tubular-shaped applicator at a rate of 7.5 grams/linear inch onto the Mat (moving at about 24 feet/minute) at locations adjacent the longitudinal edges (about 3 inches from the outer longitudinally-extending edges of the Mat) and in the center of the Mat, in a pattern as depicted in FIG. 3. The panel was cut into Products having 4′×8′ dimensions. The Products formed as described above were then evaluated according to standard methods specified by ASTM D-1037.

The results of the panel tests are summarized below in TABLE 1, as follows:

TABLE 1

| | | | |
|---|---|---|---|
| Average | Panel | | CSL |
| Thickness | Weight | Density | Load |

I. Multi-Layer Product Without Adhesive Band

| | | | | |
|---|---|---|---|---|
| Panel #1 | 0.718 | 75.0 | 39.22 | 1097.0 |
| Panel #2 - | 0.717 | 76.0 | 39.80 | 938.0 |
| Panel #3 - | 0.713 | 75.0 | 39.50 | 847.0 |
| Average | 0.716 | 75.3 | 39.51 | 960.7 |

II. Multi-Layer Product With Adhesive Band

| | | | | |
|---|---|---|---|---|
| Panel #1 - | 0.717 | 77.0 | 40.33 | 1215.0 |
| Panel #2 - | 0.714 | 77.0 | 40.50 | 1259.0 |
| Panel #3 - | 0.716 | 75.0 | 39.33 | 1323.0 |
| Average | 0.716 | 76.3 | 40.05 | 1265.7 |

The date indicates that the CSL load increased by more than 30% when bands of adhesive material were applied adjacent to the longitudinal outer edges of the multi-layer product, as shown in Table 1. II above.

### EXAMPLE 2

The subject multi-layer lignocellulosic product (“Product”) was formed according to the typical method of this inveniton (“Method”) described in EXAMPLE 1, using 7% phenol formaldehyde resin in the face layers and 3.5% MDI resin in the core layer of the Product. The target thickness was 0.720″ and the target density was 37 lb/ft3. A fiberglass reinforcing strip impregnated with MDI resin, was introduced during formation of the Product. The strip was introduced at the outer interior surfaces of the layers of lignocellulosic material, between each pair of adjacent layers, at a location adjacent to the outer edges.

The data indicated that the Edge Resistance to a Lateral Nail Pull substantially increased with the introduction of an MDI adhesive-impregnated fiberglass-reinforcing strip at the longitudinally-extending edges of the Product (“Fiberglass Reinforced Product”). A Lateral Nail Resistance (lbs) Pull Test was conducted at a distance of ¼″, ⅜″, and ½″ from the edge of the Product. At ¼″ from the edge of the Fiberglass Reinforced Product, the Lateral Nail Pull was 49% higher for the Fiberglass Reinforced Product than for a comparable conventional OSB product without reinforcement. At ⅜″ from the edge of the Fiberglass Reinforced Product, the Lateral Nail Pull was 80% higher for the Fiberglass Reinforced Product than for a comparable conventional OSB product without reinforcement. At ½″ from the edge of the Fiberglass Reinforced Product, the Lateral Nail Pull was 58% higher for the Fiberglass Reinforced Product than for a comparable conventional OSB product without reinforcement.

Having described and illustrated the principles the invention in a preferred embodiment thereof, it should be apparent that the invention can be modified in arrangement and detail without departing from such principles. I claim all modifications and variations coming within the spirit and scope of the following claims.

1. A method for forming a multi-layer lignocellulosic product, having outer interior surfaces, and a plurality of outer edges surrounding said outer interior surfaces, said product exhibiting a relatively low level of thickness swell, after wetting, of said outer interior surfaces and said outer edges, respectively, said method comprising the steps of:
providing a plurality of layers of lignocellulosic material, each of said layers of lignocellulosic material comprising outer interior surfaces and a plurality of outer edges surrounding said outer interior surfaces;
treating said layers of lignocellulosic material by introducing a band of an adhesive bonding material onto at least one of the outer interior surfaces of said layers of lignocellulosic material, between each pair of adjacent layers, at a location adjacent to at least one of said outer edges;
forming a treated mat of said layers of treated lignocellulosic material; and
bonding together said treated mat to form said multi-layer lignocellulosic product.

2. The method of claim 1, wherein said lignocellulosic material comprises lignocellulosic particles.

3. The method of claim 1, wherein said layers of lignocellulosic material comprise lignocellulosic veneers.

4. The method of claim 1, wherein said product comprises a tongue and groove multi-layer lignocellulosic product.

5. The method of claim 1, wherein said adhesive bonding material comprises any one of an isocyanate polymer, an aldehyde resin, an aldehyde resin-latex copolymer, and an isocynate resin-latex copolymer.

6. The method of claim 1, wherein said adhesive bonding material comprises a liquid.

7. The method of claim 1, wherein said multi-layer lignocellulosic product exhibits a substantially lower level of thickness swell than a multi-layer lignocellulosic product produced from an untreated mat of said plurality of layers of said lignocellulosic material to which said adhesive bonding material band has not been applied.

8. The method of claim 1, wherein at least one said band of adhesive bonding material extends in a direction substantially parallel to at least one of said outer edges of the product.

9. The method of claim 1, wherein a pair of bands of adhesive bonding material extend in a direction substantially parallel to said longitudinally-extending outer edges of the product.

10. The method of claim 1, wherein said mat comprises a plurality of longitudinally-extending outer edges and a plurality of laterally extending outer edges, and said adhesive bonding material is applied onto at least a portion of one of the laterally-extending outer edges.

11. The method of claim 1, wherein at least a portion of each said band of said adhesive bonding material is located within about 2.0 inches of the outer edges of the product.

12. The method of claim 1, wherein the Edge Swell of the multi-layer lignocellulosic product of this invention, after wetting, is preferably at least about 20% less than the Edge Swell of a multi-layer lignocellulosic product produced from an untreated plurality of layers of said lignocellulosic material to which a band of adhesive bonding material band has not been applied.

13. The method of claim 1, wherein the Edge Swell of the multi-layer lignocellulosic product of this invention, after wetting, is at least about 25% than the Edge Swell of a multi-layer lignocellulosic product produced from an untreated plurality of layers of said lignocellulosic material to which a band of adhesive bonding material band has not been applied.

14. The method of claim 1, wherein the Differential Swell of the multi-layer lignocellulosic product of this invention, after wetting, is at least about 25% less than the Differential Swell of a multi-layer lignocellulosic product produced from an untreated plurality of layers of said lignocellulosic material to which a band of adhesive bonding material band has not been applied.

15. The method of claim 1, wherein the Differential Swell of the multi-layer lignocellulosic product of this invention, after wetting, is at least about 30% less than the Differential Swell of a multi-layer lignocellulosic product produced from an untreated plurality of layers of said lignocellulosic material to which a band of adhesive bonding material band has not been applied.

16. The method of claim 1, wherein the ultimate load (extraction) of the multi-layer lignocellulosic product, after wetting, is at least about 30% less than the ultimate load (extraction) of a multi-layer lignocellulosic product produced from an untreated plurality of layers of said lignocellulosic material to which a band of adhesive bonding material band has not been applied.

17. The method of claim 1, wherein the ultimate load (extraction) of the multi-layer lignocellulosic product, after wetting, is at least about 40% less than the ultimate load (extraction) of a multi-layer lignocellulosic product produced from an untreated plurality of layers of said lignocellulosic material to which a band of adhesive bonding material band has not been applied.

18. The method of claim 1, wherein the multi-layer lignocellulosic product further includes at least one reinforcing strip joined to at least one band of adhesive bonding material.

19. The method of claim 1, wherein the reinforcing strip comprises a polymeric material.

20. The method of claim 12, wherein the Differential Swell of the multi-layer lignocellulosic product, after wetting, is at least about 25% less than the Differential Swell of a multi-layer lignocellulosic product produced from an untreated plurality of layers of said lignocellulosic material to which a band of adhesive bonding material band has not been applied.

21. A multi-layer lignocellulosic product, having outer interior surfaces, and a plurality of outer edges surrounding said outer interior surfaces, said product exhibiting a relatively low level of thickness swell, after wetting, of said outer interior surfaces and said outer edges, respectively, said product comprising:
a plurality of layers of lignocellulosic material, each of said layers of lignocellulosic material comprising outer interior surfaces and a plurality of outer edges surrounding said outer interior surfaces,
said layers of lignocellulosic material having been treated with a band of an adhesive bonding material applied onto at least one of the outer interior surfaces of said layers of lignocellulosic material, between each pair of adjacent layers, at a location adjacent to at least one of said outer edges, and bonded together to form said multi-layer lignocellulosic product.

22. The product of claim 21, wherein said lignocellulosic material comprises lignocellulosic particles.

23. The product of claim 21, wherein said layers of lignocellulosic material comprise lignocellulosic veneers.

24. The product of claim 21, wherein said product comprises a tongue and groove multi-layer lignocellulosic product.

25. The product of claim 21, wherein said adhesive bonding material comprises any one of an isocyanate polymer, an aldehyde resin, an aldehyde resin-latex copolymer, and an isocynate resin-latex copolymer.

26. The product of claim 21, wherein said adhesive bonding material comprises a liquid.

27. The product of claim 21, wherein said multi-layer lignocellulosic product exhibits a substantially lower level of thickness swell than a multi-layer lignocellulosic product produced from an untreated mat of said plurality of layers of said lignocellulosic material to which said adhesive bonding material band has not been applied.

28. The product of claim 21, wherein at least one said band of adhesive bonding material extends in a direction substantially parallel to at least one of said outer edges of the product.

29. The product of claim 21, wherein a pair of bands of adhesive bonding material extend in a direction substantially parallel to said longitudinally-extending outer edges of the product.

30. The product of claim 21, wherein said product comprises a plurality of longitudinally-extending outer edges and a plurality of laterally extending outer edges, and said adhesive bonding material is applied onto at least a portion of one of the laterally-extending outer edges.

31. The product of claim 21, wherein at least a portion of each said band of said adhesive bonding material is located within about 2.0 inches of the outer edges of the product.

32. The product of claim 21, wherein the Edge Swell of the multi-layer lignocellulosic product, after wetting, is preferably at least about 20% less than the Edge Swell of a multi-layer lignocellulosic product produced from an untreated plurality of layers of said lignocellulosic material to which a band of adhesive bonding material band has not been applied.

33. The product of claim 21, wherein the Edge Swell of the multi-layer lignocellulosic product, after wetting, is at least about 25% than the Edge Swell of a multi-layer lignocellulosic product produced from an untreated plurality of layers of said lignocellulosic material to which a band of adhesive bonding material band has not been applied.

34. The product of claim 21, wherein the Differential Swell of the multi-layer lignocellulosic product, after wetting, is at least about 25% less than the Differential Swell of a multi-layer lignocellulosic product produced from an untreated plurality of layers of said lignocellulosic material to which a band of adhesive bonding material band has not been applied.

35. The product of claim 21, wherein the Differential Swell of the multi-layer lignocellulosic product, after wetting, is at least about 30% less than the Differential Swell of a multi-layer lignocellulosic product produced from an untreated plurality of layers of said lignocellulosic material to which a band of adhesive bonding material band has not been applied.

36. The product of claim 21, wherein the ultimate load (extraction) of the multi-layer lignocellulosic product, after wetting, is at least about 30% less than the ultimate load (extraction) of a multi-layer lignocellulosic product produced from an untreated plurality of layers of said lignocellulosic material to which a band of adhesive bonding material band has not been applied.

37. The product of claim 21, wherein the multi-layer lignocellulosic product further includes at least one reinforcing strip joined to at least one band of adhesive bonding material.

38. The product of claim 21, wherein the reinforcing strip comprises a polymeric material.

39. The product of claim 21, wherein the CSL Load of the multi-layer lignocellulosic product, after wetting, is at least about 25% less than the CSL Load of a multi-layer lignocellulosic product produced from an untreated plurality of layers of said lignocellulosic material to which a band of adhesive bonding material band has not been applied.

40. The product of claim 21, wherein the Differential Swell of the multi-layer lignocellulosic product, after wetting, is at least about 25% less than the Differential Swell of a multi-layer lignocellulosic product produced from an untreated plurality of layers of said lignocellulosic material to which a band of adhesive bonding material band has not been applied.

41. A substantially flat, integrated arrangement formed of multi-layer lignocellulosic products, each product having a plurality of outer edges and first and second outer surfaces respectfully, said product exhibiting a relatively low degree of difference thickness swell, after wetting, between said outer surfaces and said outer edges, respectively, comprising the steps of:
a plurality of layers of lignocellulosic material, having first and second outer surfaces; and
at least one band of an adhesive bonding material applied on at least one of the first and second outer surfaces, between each pair of adjacent layers, at a location extending adjacent to at least one of the outer edges of the product, for bonding together said plurality of layers of lignocellulosic material.

42. A method for forming a substantially flat, integrated arrangement formed of multi-layer lignocellulosic products, having a plurality of outer surfaces, a plurality of outer edges, said product exhibiting a relatively low degree of difference in thickness swell, after wetting, between said outer surfaces and said outer edges, respectively, comprising the steps of:
providing a mat formed of a plurality of layers of lignocellulosic material, having first and second outer surfaces,
treating said mat by applying at least one band of an adhesive bonding material to at least one of the first and second outer surfaces of said mat, between each pair of adjacent layers, at a location adjacent to at least one of said outer edges; and
bonding together said plurality of layers of lignocellulosic material of said treated mat to form said multi-layer lignocellulosic product; and
forming a substantially flat, integrated arrangement of said plurality of multi-layer lignocellulosic products.
